(19) United States
(12) Patent Application Publication
(10) Pub. No.: US 2012/0290220 A1
(43) Pub. Date: Nov. 15, 2012

(54) SYSTEM AND METHOD FOR CALCULATING GREENHOUSE GAS EMISSIONS IN THE PRODUCTION OF RAW MATERIAL FOR OBTAINING BIOPRODUCTS

(75) Inventors: Ricardo ARJONA ANTOLIN, Sevilla (ES); Maria de las Nieves Valenzuela Romero, Sevilla (ES); Beatriz Alonso Martinez, Madrid (ES); Raquel Diaz Molist, Madrid (ES); Rocio Garcia Encinas, Sevilla (ES); Maria Angeles Gutierrez Montero, Sevilla (ES); Jesus Yanez Vidal, Sevilla (ES); Laura Montes Garcia, Sevilla (ES); Jesus Lopez Lopez, Sevilla (ES); Marcarena Marquez Pinuela, Sevilla (ES); Ines Echeverria Goni, Sarriguren (ES); Eduardo Otazu Vidart, Sarriguren (ES); David Sanchez Gonzalez, Sarriguen (ES); Goizeder Barberena Ibanez, Sarriguren (ES)

(73) Assignee: ABENGOA BIOENERGIA NUEVAS TECNOLOGIAS, S.A., Sevilla (ES)

(21) Appl. No.: 13/165,874

(22) Filed: Jun. 22, 2011

(30) Foreign Application Priority Data
May 9, 2011 (EP) 11382133.4

(51) Int. Cl. G06F 19/00

(52) U.S. Cl. 702/24

(57) ABSTRACT

For quickly and remotely obtaining the GHG emissions, without providing the sites of raw material production with means for collecting parameters. The system comprises a processing unit to execute instructions related to the determination of the emissions; the database for storing the relevant parameters related to the processes for the production of raw material; a data transmission means connected to the database and the processing unit, to retrieve said parameters from the database and transmitting said parameters to the processing unit, and a GHG emissions modeling module connected to the processing unit and adapted to generate a GHG emissions level. The method comprises considering a partial calculation for the emissions related to any process and adding them up to obtain an overall value for said GHG emissions.

### CROSS REFERENCE TO RELATED APPLICATION

This application claims priority upon European Application No. EP11382133.4, filed May 9, 2011. This application is hereby incorporated by reference in its entirety for all of its teachings.

### OBJECT OF THE INVENTION

The invention hereby disclosed is related to the field of sustainability and environmental control in the production of raw material for obtaining bioproducts.

The objective of the invention is a system and a method for calculating the value of greenhouse gas (GHG) emissions in the production of raw material for obtaining bioproducts.

### BACKGROUND OF THE INVENTION

Bioproducts include building materials, pulp and paper, forest products, biofuels, bioenergy, starch-based and cellulose-based ethanol, bio-based adhesives, biochemicals, bioplastics, etc. Bioproducts are active subjects of research and development, and these efforts have developed significantly since the turn of the 20/21st century, mainly driven by the environmental impact of petroleum use. Bioproducts derived from bioresources can replace much of the fuels, chemicals, plastics, etc. that are currently derived from petroleum.

For example, as a sort of bioproduct, bioenergy is renewable energy made available from materials derived from biological sources and includes different forms, such as: biofuels, bioliquids, biogas, renewable electricity and renewable thermal energy. In its most narrow sense it is a synonym to biofuel, which is fuel derived from biological sources. In its broader sense it includes biomass, the biological material used as a biofuel, as well as the social, economic, scientific and technical fields associated with using biological sources for energy. This is a common misconception, as bioenergy is the energy extracted from the biomass, as the biomass is the fuel and the bioenergy is the energy contained in the fuel.

Biomass is any organic material which has stored sunlight in the form of chemical energy. As a fuel it may include wood, wood waste, straw, manure, sugarcane, and many other bioproducts from a variety of biological processes.

There is a slight tendency for the word bioproduct to be favoured in Europe compared with biofuel in North America; bioproduct means renewable energy obtained from biological materials, and includes: biofuels, bioliquids, biogas, renewable electricity and renewable thermal energy.

As an example of bioproduct, biofuels are gaining increased public and scientific attention, driven by factors such as oil price spikes, the need for increased energy security, and concern over greenhouse gas emissions from fossil fuels. Biofuels are used among others for ETBE production (gasoline additive), or for direct blending with gasoline or diesel. Being renewable energy sources, biofuels reduce CO₂ emissions, and contribute to the security and diversification of the energy supply, while reducing the dependency on fossil fuels in the transportation and helping towards compliance with the Kyoto Protocol.

In some way it seems to be clear that the use of raw material to produce a bioproduct is an alternative to the use of other fossil fuels thus producing less GHG, but it is necessary to make sure that the total emissions related to said bioproducts are not higher than the emissions related to the fossil fuels.

Most of the GHG emissions related to bioproducts can be associated to the production processes of raw material for obtaining said bioproducts. Therefore it is necessary to focus on the reduction of GHG emissions related to such processes for production of raw material.

Obtaining in the production sites of said raw material the relevant parameters for obtaining the GHG emissions related to the production of raw material is usually not possible due to the large amount of time and resources which have to be consumed for collecting said parameters.

Therefore, there is a necessity of quickly and remotely calculating the GHG emissions in the production of raw material, without providing the sites of production with means for collecting parameters. The GHG emissions should be known before the taking of the decision of buying said raw material.

### DESCRIPTION OF THE INVENTION

The invention relates to a system and a method for determining the GHG emissions involving the different processes and steps for the production of raw material for obtaining a bioproduct. The specific purpose of this invention is to describe the obtaining of GHG emission relative to the production processes of raw material for obtaining a form of bioproduct.

Bioproducts comprise bioenergy, as well as products like bioplastics, Furfural, APP, APG, Fumaric Acid, Acetic Acid, Lactic Acid, Xylitol, PHA, Sorbitol, Itaconic Acid, Adipic Acid, 1,4-butanediol, 1,3-propanediol, Succinic Acid, Acrylic Acid, Resins, Carbon fiber, Phenol, or Quinones, among others.

A form of bioenergy may be biofuels, such as bioethanol or biodiesel, or may be biogas, bioliquids, renewable electricity or renewable thermal power, among others.

Next, some definitions corresponding to some terms which will be used below are provided.

Processing unit: any device (for instance, a computer) adapted to receive/retrieve data from databases or storing means (such as a readable memory), perform calculations and send the result of the calculations to output means (screen, printer, etc)

Parameter calculated: parameter that can be obtained from other.

Reference values: Values obtained from databases and literature data for the same product or process or related ones.

Activity data: a characteristic parameter of the activity or of the means used to perform each process, which allows determining the emissions for a given period through calculation.

Emission factor: a parameter that indicates the quantity of a particular GHG emitted directly or indirectly from a particular process by unit of activity data.

According to a first aspect, the invention relates to a system for calculating greenhouse gas (GHG) emissions in the production of raw material for obtaining a bioproduct, comprising: at least one processing unit adapted to execute instructions related to the determination of GHG emissions in the production of raw material for obtaining bioproducts; at least one database, accessible by at least the processing unit, and adapted for storing at least one relevant parameter related to the processes for the production of raw material; data transmission means adapted to transmit data and connected to at least both the database and the processing unit; and a GHG emissions modeling module embodied as a software and connected to the processing unit and adapted to generate a GHG emissions level, in co-operation with said processing unit, wherein the at least one database is accessible by at least the processing unit by means of the data transmission means.

It is preferred that the relevant parameters comprise parameters retrieved, with the mediation of retrieving means, from a storing means, said storing means storing information relating to the production of raw material for obtaining bioproducts.

Preferably, the processing unit comprises: at least one processor adapted to process at least the GHG emissions parameters; al least one memory connected to the processor; and storage means accessible by the processing unit and adapted to store at least some instructions related to the process of at least the GHG emissions parameters.

The data transmission means are preferably selected from the group consisting of: wired communication means, wireless communication means and near field communication means.

The database may preferably further comprise at least a quality index relating to at least one of the relevant parameters. The quality index indicates the reliability of the parameter to which it refers. The lower the quality index is, the higher the reliability for the parameter is.

The database may preferably be allocated at a server accessible by the GHG emissions modeling module and/or the processing unit. As an alternative, the database may be allocated at the storage means.

Preferably, the system further comprises displaying means for representing the GHG emissions.

According to a second aspect, the invention relates to a method for calculating greenhouse gas (GHG) emissions related to the production of raw material intended to be transformed in bioproduct(s), using the system described above, the production of raw material comprising: processes for extraction and cultivation of raw material; processes for collection of raw material; processes for treatment of raw material waste and leakages; and processes for production of chemicals or products used in extraction and cultivation of raw material, wherein the method comprises the steps of:

a) retrieving from the database by means of the GHG emissions modeling module, using instructions received from the processing unit, relevant parameters related to processes for extraction and cultivation of raw material;

b) retrieving from the database by means of the GHG emissions modeling module, using instructions received from the processing unit, relevant parameters related to processes for collection of raw material;

c) retrieving from the database by means of the GHG emissions modeling module, using instructions received from the processing unit, relevant parameters related to processes for treatment of raw material waste and leakages;

d) retrieving from the database by means of the GHG emissions modeling module, using instructions received from the processing unit, relevant parameters related to processes for production of chemicals or products used in extraction and cultivation of raw material;

e) providing the processing unit, through the data transmission means, with said relevant parameters, said processing unit having instructions for calculating the GHG emissions by means of the GHG emissions modeling module to which is connected;

f) processing in the processing unit the relevant parameters related to each process involved in the raw material production for calculating a partial GHG emissions value related to each process, and

g) adding up said partial values for calculating an overall GHG emissions level.

Preferably, the processing step f) comprises multiplying an activity data by an emission factor, being the activity data a characteristic parameter of the activity or of the means used to perform each process, which allows determining the emissions for a given period through calculation, and being the emission factor a parameter that indicates the quantity of a particular GHG emitted from a particular process by unit of activity data. Preferably the activity data for a process could be composed by a combination of several parameters and constant factors.

It is preferred that the raw material extraction and cultivation processes comprises at least one process selected from: soil tillage; seed fabrication, sowing; irrigation; fertilizer application; pesticides application; NO₂ direct and indirect emissions from soil and organic amendments. The recovering step a) may comprise at least one action selected from:

retrieving, from the database by means of the GHG emissions modeling module, using instructions received from the processing unit, relevant parameters for the energy consumption during tillage operation;

retrieving, from the database by means of the GHG emissions modeling module, using instructions received from the processing unit, relevant parameters related to the quantity of seed fabrication;

retrieving, from the database by means of the GHG emissions modeling module, using instructions received from the processing unit, relevant parameters for the energy consumption of a sowing machinery;

retrieving, from the database by means of the GHG emissions modeling module, using instructions received from the processing unit, relevant parameters for the energy consumed in pumping irrigation water;

retrieving, from the database by means of the GHG emissions modeling module, using instructions received from the processing unit, relevant parameters for the energy consumption in the fertilizer application;

retrieving, from the database by means of the GHG emissions modeling module, using instructions received from the processing unit, relevant parameters for the energy consumption for applying pesticides;

retrieving, from the database by means of the GHG emissions modeling module, using instructions received from the processing unit, parameters relevant for the N₂O direct and indirect emissions: these emissions are associated to nitrous oxide emissions from soil due to direct nitrogen emissions, as well as leaching and volatilization of nitrogen;

retrieving, from the database by means of the GHG emissions modeling module, using instructions received from the processing unit, parameters relevant for the emissions related to organic amendments application: these emissions are associated to substitution of nitrogen-based inorganic fertilizer.

Preferably, the processes for collection of raw material comprise at least one process selected from: harvesting of raw material; transport of raw material inside the parcel; transport of raw material to the raw material storing site; storage of raw material; and drying of raw material. The recovering step b) may comprise at least one action selected from:

retrieving, from the database by means of the GHG emissions modeling module, using instructions received from the processing unit, relevant parameters for the energy consumption of a harvesting machinery;

retrieving, from the database by means of the GHG emissions modeling module, using instructions received from the processing unit, relevant parameters for the energy consumption of a transport means for transporting the raw material inside the parcel;

retrieving, from the database by means of the GHG emissions modeling module, using instructions received from the processing unit, relevant parameters for the energy consumption of a transport means for transporting the raw material from the parcel to the harvested raw material storage site;

retrieving, from the database by means of the GHG emissions modeling module, using instructions received from the processing unit, relevant parameters for the energy consumption related to the load and unload of the raw material inside de storage site and the maintenance of controlled conditions in said storage site;

retrieving, from the database by means of the GHG emissions modeling module, using instructions received from the processing unit, relevant parameters for the energy and/or fuel consumption in raw material drying operations.

It is preferred that the processes for treatment of raw material waste and leakages comprise at least one process selected from: raking; baling, bale collecting and bale transporting. The recovering step c) may comprise at least one action selected from:

retrieving, from the database by means of the GHG emissions modeling module, using instructions received from the processing unit, relevant parameters for the energy consumption of a raking machine;

retrieving, from the database by means of the GHG emissions modeling module, using instructions received from the processing unit, relevant parameters for the energy consumption of a baling machine;

retrieving, from the database by means of the GHG emissions modeling module, using instructions received from the processing unit, relevant parameters for the energy consumption of a machine for collecting bales; and

retrieving, from the database by means of the GHG emissions modeling module, using instructions received from the processing unit, relevant parameters for the energy consumption of a machine for transporting said bales to a bale storage site.

Preferably, the processes for production of chemicals or products used in extraction and cultivation of raw material comprise at least one process selected from: fabrication of fertilizers and fabrication of pesticides. The recovering step d) may comprise at least one action selected from:

retrieving, from the database by means of the GHG emissions modeling module, using instructions received from the processing unit, relevant parameters related to the composition and quantity of fertilizer used; and

retrieving, from the database by means of the GHG emissions modeling module, using instructions received from the processing unit, relevant parameters related to the composition and quantity of pesticide used.

The partial GHG emissions factor related to the fertilizer fabrication may be preferably calculated as a weighted average of the emission factor of each type of fertilizer according to the quantity used in each geographical area.

The quantity of fertilizer used (i.e. the corresponding activity factor) may be estimated following from parameters relating to the overall production of raw material; the overall consumption of fertilizer; the theoretical fertilization ratio; and the overall surface involved in the production of raw material, according to the next steps:

retrieving from the database, by means of the GHG emissions modeling module, using instructions received from the processing unit, a parameter related to the overall production of raw material;

retrieving from the database, by means of the GHG emissions modeling module, using instructions received from the processing unit, a parameter related to the overall consumption of fertilizer;

retrieving from the database, by means of the GHG emissions modeling module, using instructions received from the processing unit, a parameter related to the theoretical fertilization ratio indicating the quantity of raw material produced per area unit;

retrieving from the database, by means of the GHG emissions modeling module, using instructions received from the processing unit, a parameter related to the overall surface involved in the production of raw material,

transmitting, using the data transmission means, the parameters calculated in the previous steps to the processing unit, and

calculating, using the GHG emissions modeling module, the quantity of fertilizer used, by adjusting the real fertilizer consumption with the theoretical fertilization ratio.

The relevant parameters preferably comprise parameters related to the type of the raw material and the location of the production of the raw material.

The type of raw material may be selected from any sort of organic material which may be transformed in any kind of bioproducts. Preferably raw material is selected from at least one from: cereals, sugar cane, straw, forestry material (such as trees), forestry residues, organic waste, wine alcohol, aquaculture and fishery residues and oleaginous crops, as well as energy crops, among others.

According to a preferred embodiment, the relevant parameters stored in the database may be accompanied with a quality index relating said parameters, following preset criteria. The lower the quality index is, the higher the reliability for parameter value is. The method of the invention is intended to be subject to a continuous improvement process, one aspect of which is storing in the database updated parameters with the highest reliability available. Therefore, before storing an updated parameter, a comparison should be done between the index quality relating the updated parameter and the quality index relating the current parameter, so that the updated parameter substitutes the stored parameter if the quality index relating said updated parameter is lower than the one relating the current parameter, according to the preset criteria.

The system and the method of the invention allow the determination of the value of greenhouse gas (GHG) emissions in the production of raw material for obtaining bioproducts, without needing to provide the production sites for raw material with means for collecting the relevant parameters. After all relevant parameters are stored in the database, the system of the invention can calculate the overall GHG emissions for a determined raw material relating to a determined raw material production site.

### DESCRIPTION OF A PREFERRED EMBODIMENT

A first object of the invention is a system for determining the GHG (greenhouse gas) emissions involved in the production of raw materials intended to be transformed in bioproducts. A preferred embodiment is described below on a basis of raw material intended to be transformed in biofuel as a particular bioproduct. A second object is a method for determining said GHG emissions.

The raw materials intended to be transformed in biofuel can be of various types, for example: barley, wheat, corn, sorghum, sugar cane, straw, forestry residues, forestry materials, organic waste, wine alcohol, aquaculture and fishery residues, and oleaginous crops, as well as energy crops, among others. The production of raw material can be located in various places all over the world.

The raw material production involves a number of processes. These processes may be classified in the next groups:

processes for extraction and cultivation of raw material;

processes for collection of raw material;

processes for treatment of raw material waste and leakages; and

processes for production of chemicals or products used in the extraction or production of raw material.

Each of the groups of processes identified above comprises a plurality of other processes. For example:

processes for extraction and cultivation of raw material comprise: soil tillage, seed fabrication, sowing, irrigation, fertilizer application, pesticides application, N₂O direct and indirect emission from soil and organic amendment application;

processes for collection and storage of raw material comprise: harvesting, transport of harvested biomass inside the parcel of production, transport of harvested biomass to a initial storage site, storage of the harvested biomass, and drying of the harvested biomass.

processes for treatment of raw material waste and leakages comprise: raking, baling, bale collection, and bale transporting; and transporting bales to storage.

processes for production of chemicals or products used in the extraction or production of raw material comprise: fabrication of fertilizers and pesticides.

i) Emissions from the Extraction and Cultivation Process.

Tillage (energy consumption). The emissions due to tillage are directly due to the energy consumption. Within this method, an average ratio for each geographical area is established. The emissions are calculated with an estimation of the machinery energy consumption during operation and multiplying for the corresponding emission factor.

Seed fabrication. The emissions related to the seed fabrication are directly due to the quantity of seed consumed in the seeding process, multiplied by the seed fabrication emission factor.

Sowing. The emissions are calculated with an estimation of the machinery energy consumption during the operation and multiplying by the corresponding emission factor.

Irrigation. The method estimates the energy consumed for the water pumping at the pressure needed and multiplying by the emission factor depending of the energy mix of each geographical area.

Fertilizer application. The emissions are calculated with an estimation of the machinery energy consumption during the operation and multiplying by the corresponding emission factor.

Pesticides application. The emissions are calculated with an estimation of the machinery energy consumption during each operation and multiplying by the corresponding emission factor.

N₂O direct and indirect emissions: these emissions are associated to nitrous oxide emissions from soil due to direct nitrogen emissions, as well as leaching and volatilization of nitrogen, multiplied by the corresponding emission factor.

Organic amendments application: The emissions are calculated through an estimation of the machinery energy consumption during each operation and multiplying by the corresponding emission factor. Additionally these emissions are associated to substitution of nitrogen-based inorganic fertilizer.

ii) Emissions from the Collection of Raw Material.

Harvesting. The emissions are calculated with an estimation of the harvester energy consumption during the operation and multiplying by the corresponding emission factor.

Raw material field transport. The method considers the transportation of the raw material within the parcel. The emissions are calculated with an estimation of the harvester energy consumption during the operation and multiplying by the corresponding emission factor.

Transport of raw material to storage. The method considers the emission associated to the transport of raw material from the parcel to the initial storage where it is compiled. The emissions are calculated with an estimation of the energy consumption during the transportation of raw material and multiplying by the corresponding emission factor.

Storage operation. The method considers the consumption due to daily operation in the storage (energy consumption, gas, etc). The method considers multiplying the corresponding emission factor by an estimation of the energetic consumption due to the loading and unloading of the raw material and the internal movements of said raw material for the aeration and maintenance in controlled conditions.

Drying of raw material. It has been considered that diesel; natural gas and electricity can be used for the drying of raw material, so it is possible to select each type of energy. The method considers multiplying the energy consumption during the drying process by the corresponding emission factor.

iii) Emissions from Waste and Leakages:

Raking. The method considers a swept of the straw spread out on the soil. The GHG emissions are related to the energy consumption during operation, multiplying by the corresponding emission factor.

Baling. The method considers the straw collection and baling forming bales that are placed on the soil. The GHG emissions are related to the energy consumption during operation, multiplying by the corresponding emission factor.

Collecting bales. The method considers the collection of the straw bales and preparation to be transported to the storage. The GHG emissions are related to the energy consumption during operation, multiplying by the corresponding emission factor.

Transport bales to storage. The method considers the transportation from the parcel to the first storage. The GHG emissions are related to the energy consumption during operation, multiplying by the corresponding emission factor.

iv) Emissions from the Production of Chemicals or Products Used in Extraction and Cultivation.

Fabrication of fertilizers N, P and K. The method is based on an activity fertilizer and an emission factor. The emissions factor for the fertilizer fabrication is calculated as a weighted average of the emission factor of each type of fertilizer according to the quantity used in each geographical area.

Pesticides fabrication. The method is based on an activity data of pesticides consumed from statistics, or other sources and an emission factor.

As stated above, each of the processes identified above (for example, sowing or raw material storing) require the use of machinery and/or products/chemicals, as well the consumption of energy and/or fuel.

Each of said processes is defined by parameters which are stored in a database where they are stored at the disposal of a user. For example, a parameter would be the energy consumption of a sowing truck or the energy consumption (electricity or gas, for instance) for maintaining suitable temperature and humidity in a storing site.

A processing unit is arranged to process the parameters for calculating the GHG emissions. A transmitting means is connected to both the processing unit and the database and performs the tasks of recovering the parameters from the database and transmitting said parameters to the processing unit.

The processing unit calculates the GHG emission assigned to a quantity of produced raw material in a level by level sequence as will be explained below: As stated above, the raw material production is divided in groups of processes, each involving some processes which may on tour be subdivided defining as many levels as necessary to cover all necessary actions related to the raw material production. The processing unit is arranged to calculate the GHG emissions of every action or component in the lowermost level according to the next formula:

PartialGHGEmissionValue=ActivityData·EmissionsFactor

and then to add them up to determine a partial result for the GHG emissions relating to that level, and then consecutively sum the emissions corresponding to all the levels until the overall GHG emission values corresponding to the entire production of raw material are finally obtained.

For example, calculating the GHG emissions related to producing the fertilizers involve adding up the calculation of the partial GHG emissions related to the production of any component of the fertilizer (Nitrogen, Phosphorus, etc).

In a similar way the emissions related to the production of pesticides are calculated. Both fertilizers and pesticides emissions are added up to determine the emissions related to the processes for production of chemicals or products used in the extraction or production of raw material and then added up with partial emissions determined analogously for the processes for extraction and cultivation of raw material, the processes for collection of raw material and the processes for treatment of raw material waste and leakages, to obtain an overall value for said GHG emissions.

According to what is stated above, the GHG emissions relating the entire production process of raw material is calculated according to the following formula, where “i” relates to each of the total of “n” process, sub process, operation, etc.

$${Emissions}_{Operation \_ i} = {\sum }_{i = 1}^{n} ( {ActivityData}_{i} \cdot {EmissionsFactor}_{i} )$$

wherein:
n is the number of operations in a stage, in which:
Activity data: is a characteristic parameter of the activity or of the equipment, installations, processes or vehicles associated with a given source, which allows determining their emissions for a given period through calculation. Examples of activity data are the energy consumption, the consumption of raw material, the distance covered by vehicles, etc. The value of each activity data could vary due to different raw material types, geographical area or also with the cultivation conditions. The resulting activity data for a defined sub operation could be composed by a combination of several parameters and constant factors.
Emission Factor: is a parameter that indicates the quantity of a particular GHG emitted from a particular activity by unit of product, volume, duration, quantity of raw material or energy etc, and that is by unit of what has been designated as “activity data”. The value of each emission factor could vary due to different raw material types, geographical area or also with the cultivation operations.

It is worth mentioning that both the activity data and the emission factor may be calculated from the same parameter/s, or it is also feasible to calculate the activity data value from one or more parameters and the emission factor from one or more parameters different to those used to calculate the activity data; furthermore when using more than one parameter to calculate either the emission factor or the activity data, it might happen than one of those parameters is used to calculated both the activity data and the emission factor.

The sequential calculation per process or sub operation is the same:
1) Selection of the corresponding sub operation per each process depending of the raw material production site and raw material type.
2) Selection of the parameters needed in each sub operation to be incorporated within the calculation formula. These parameters cover both emissions factor and activity data.
3) Calculation performance using the corresponding formula and parameters for each suboperation.

Results for each subtask and the final result of the stage analyzed adding the individual result of each task integrated for its corresponding sub tasks.

The value for GHG emissions will be related to a CO₂ equivalent value. For the purpose of calculating said CO₂ equivalent value, the gases to be valued are at least one from: CO₂; N₂O; CH₄; HFC's; PFC's and SF₆.

The parameters can show or not show a dependency on the type of raw material, as well as said parameters may on tour show or not show a dependency on the geographical level. Said dependency on the geographical level means that the parameters show different values if they are determined considering corresponding processes related to different areas, for example, some parameters for sowing may depend or not depend of whether the sowing takes place in France or in the USA.

The parameters may be determined from the processes for raw material production or may be determined by taking said parameters from collected data such as data bases and/or literature data with/without dependency on cultivation. Irrespective of whether there is o there is not a dependency of the geographical level, the parameters collected from data bases and/or literature data may have different geographical scope (country, continental o global scope). It means that the data may be collected from data bases or literature relating to NUTS 3, to NUTS 2 o to country. The quality index related to the geographical scope of the literature or data basis is higher the narrower the geographical scope is.

As stated above, the parameter values stored in the database are accompanied by a quality index, giving information about the reliability of said parameter value, which may have several components. One of said components is related to the geographical scope of the literature or data basis in which said parameter value has been found. The value for said component is higher the narrower the geographical scope is. In this case, as NUTS 3 relates to a narrower geographical scope than NUTS 2 or country, a value for a parameter which is found in a NUTS 3 geographical scope has lower component for the quality index relating to geographical scope, and hence, higher reliability.

There is also a component of the quality index related to the type of the source (database or literature) from which the data are collected. According to it, the data may come from (decreasing quality level, therefore increasing the component of quality index) statistical data from official bodies, statistical data from prestigious sources or published technical/scientific reports. If no data are found following these types of source for the geographical area in which the raw material production for which the data are being searched is occurring, then data from another geographical area or raw material with agronomical conditions similar must be considered, which will have a higher component for the quality index (lower reliability).

There is also a component for the quality index which is related to the relevant date for which the data are selected. If the data come from the current year, the component for the quality index is lower (higher reliability) than that related to data selected from a previous year.

As will be explained below, the quality index for any parameter value has three components: (a, b, c) in case of dependency of geographical level, or (b, a, c) in case of not dependency of geographical level (i.e. the value for the parameter depends or not on the cultivation origin of the raw material to which the parameter relates). Component “a” refers to the geographical level of the database or literature in which the value for the parameter is found. Component “b” refers to the type of source in which the value is found. Component “c” refers to the date for which the value is found.

For several quality indexes relating to the same parameter, the quality level (and hence the reliability) is higher the lower the first component (“a”, in case of dependency, “b” in case of no dependency on the geographical level) is. For several quality indexes relating to the same parameter, which have the same value for the first component, the quality level is higher the lower the second component is. Accordingly, for several quality indexes relating to the same parameter, which have the same value for the first and the second components, the quality level is higher the lower the third component is.

According a quality index for any parameter value is useful for improving the reliability of the GHG emission value obtained, since it allows substituting a current value for a determined parameter stored in the database by a new value only if, after comparing the quality indexes for both values, the quality index associated to the new value shows higher reliability than that associated to the current value.

Next, the determination of the quality index for the parameters determined by taking them from literature or databases is explained, wherein the parameters do not show dependence on the cultivation, i.e. the type of raw material considered.

First, a parameter identification has to be performed. It means that the first task aims to identify the parameters that shall be used. The parameters may be Activity Data or Emission Factors.

Next, it is necessary to identify whether the parameter depends on the geographical level. (For example, emission factor for electricity depends on the mix of technologies used to produce it, so it has dependency on the geographical level, whilst truck energy consumption is considered no to have dependency on the geographical level). Next, option 1 relates to dependency and option 2 relates to not dependency on the geographical level.

Option 1: Dependency on the Geographical Level.

As stated above, the component relating to the geographical level is referred as “a”. When there is a dependency on the geographical level, the most important criterion when assessing the quality index is the geographical scope of the data base or the literature from which the parameter is collected. It means that, when there is dependency on the geographical level, “a” is the first component of the quality index. Three geographical levels are considered: NUTS 3, NUTS 2 or country. The component “a” has value 1 for a parameter value found in a NUTS 3 database, value 2 for NUTS 2 and value 3 for country.

As stated above, the component relating to the source type is referred as “b”. When there is a dependency on the geographical level, the second most important criterion when assessing the quality index, (after the geographical level) is the source type. It means that, when there is dependency on the geographical level, “b” is the second component of the quality index. Four source types are considered: Statistical data from official bodies, statistical data from prestigious sources, published technical/scientific reports, and data from other regions. The component “b” has value 1 for a parameter value found in a statistical data from official bodies, value 2 for statistical data from prestigious sources, value 3 for published technical/scientific reports, and value 4 for data taken from other regions.

As stated above, the component relating to the date is referred as “c”. Irrespective whether there is or not dependency on the geographical level, the third most important criterion when assessing the quality index, (after the geographical level and the source type, or vice versa) is the source type. It means that “c” is the third component of the quality index. Four date types are considered: harvest year, harvest year approach, multi-year average and last available year. The component “b” has value 1 for a parameter value found for the harvest year, value 2 for harvest year approach, value 3 for multi-year average, and value 4 for last available year.

The value for any parameter is found following an iterative search. It is searched first through a combination related to the highest level of quality, i.e. quality index=(1, 1, 1). It means, a search is performed for NUTS 3 (a=1), statistical data from official bodies (b=1) and harvest year (c=1). If no value is found for said parameter having a quality index=(1, 1, 1), then the search is performed aiming to find the value relating to the next best quality index (1, 1, 2), according to what has been explained above. The iterative search goes on, on a basis of reducing the quality index, until a value for said parameter is found. The quality index associated to the successful search is accorded to said parameter value.

The series of quality indexes is (1, 1, 1); (1, 1, 2); (1, 1, 3); (1, 1, 4); (1, 2, 1); (1, 2, 2); (1, 2, 3); (1, 2, 4); (1, 3, 1); (1, 3, 2); (1, 3, 3); (1, 3, 4); (2, 1, 1); (2, 1, 2); (2, 1, 3); (2, 1, 4); (2, 2, 1); (2, 2, 2); (2, 2, 3); (2, 2, 4); (2, 3, 1); (2, 3, 2); (2, 3, 3); (2, 3, 4); (3, 1, 1); (3, 1, 2); (3, 1, 3); (3, 1, 4); (3, 2, 1); (3, 2, 2); (3, 2, 3); (3, 2, 4); (3, 3, 1); (3, 3, 2); (3, 3, 3); and (3, 3, 4).

In this way, the value found for a parameter has always the best quality index possible with regard to the available data.

Option 2: When the parameter does not have a meaningful dependency on geographical level, the most important criterion to assess the quality index is the type of source, the second most important criterion is the geographical level and the third most important criterion is the date. It means that an iterative search is performed, similar to the one explained for option 1, only differing in that the components of the quality index are (b, a, c) instead of (a, b, c).

Next, the determination of the quality index for the parameters determined by taking them from literature or databases is explained, wherein the parameters show dependence on the cultivation.

Similarly as in the case of no dependency of cultivation explained above, first of all, the relevant type of parameter has to be identified.

Then, an iterative search similar to the one explained above relating the cases of no dependency of cultivation (option 1 and option 2) has to be performed. The order, in this case is, for the quality index is (a, b, c).

If, after having tried to perform an search corresponding to the less reliable quality index (3, 3, 4), i.e. country level, published reports and last available year, no value is found, it is necessary to perform an additional secondary iterative search, as will be explained below:

In the case of the secondary search, the order for the quality index is (b, a, c). Additionally, the source types (component “b”) are (in this order): methodological hypotheses, assign data from other geographical levels, and assign data from other raw materials, instead of statistical data from official bodies, statistical data from prestigious sources and published reports, respectively, as explained above.

Methodological hypothesis, which is related to a value of 1 for the component “b”, involves following documented and justified assumptions for estimating the value of the parameter considering the same raw material and the same geographical level of the parameter involved. Assign data from other geographical level is related to the value of 2 for the component “c”. (For example, if a parameter for corn in Spain is searched and there are no valid hypotheses for corn in Spain, the search is performed for corn in France.) Assign data from other raw material is related to a value of 3 for the component “c”. (For example, wheat in Spain).

1. A system for calculating greenhouse gas (GHG) emissions in the production of raw material for obtaining bioproducts, characterized in that it comprises:
at least one processing unit adapted to execute instructions related to the calculation of GHG emissions in the production of raw material for obtaining bioproducts,
at least one database accessible by at least the processing unit and comprising at least one relevant parameter related to the processes for the production of raw material;
data transmission means adapted to transmit data and connected at least to the database and the processing unit, and
a GHG emissions modeling module embodied as a software and connected to the processing unit and adapted to calculate a GHG emissions level in co-operation with said processing unit,
wherein the at least one database is accessible at least by the processing unit by means of the data transmission means.

2. The system of claim 1, wherein the relevant parameters comprise parameters retrieved from a storing means, with the mediation of retrieving means, said storing means storing information relating to the production of raw material for obtaining bioproducts.

3. The system of claim 1, wherein the processing unit comprises:
at least one processor adapted to process at least the GHG emissions parameters;
at least one memory connected to the processor; and
storage means accessible by the processing unit adapted to store at least some instructions related to the process of at least the GHG emissions parameters.

4. The system of claim 1, wherein the data transmission means are selected from the group consisting of: wired communication means, wireless communication means and near field communication means.

5. The system of claim 1, wherein the database further comprises at least a quality index relating to at least one of the relevant parameters.

6. The system of claim 1, wherein the database is allocated at a server accessible by the GHG emissions modeling module and/or the processing unit.

7. The system of claim 1, wherein the database is allocated at the storage means.

8. The system of claim 2, wherein the relevant parameters are selected from the group comprising: energy consumption; quantity of seed fabrication;
composition and quantity of pesticide used; consumed electricity; N₂O direct and indirect emissions from soil; organic amendments application; the overall production of raw material; the overall consumption of fertilizer; the theoretical fertilization; and the overall surface involved in the production of raw material.

9. The system of claim 1, wherein the raw material is selected from at least one from the group consisting of: cereals, sugar cane, straw, forestry residues, forestry materials, organic waste, wine alcohol, energy crops, aquaculture and fishery residues and oleaginous crops.

10. The system of claim 1, wherein the bioproduct comprises a form of bioenergy.

11. The system of claim 1, wherein the bioproduct comprises a bioplastic.

12. The system of claim 10, wherein the form of bioenergy is selected from the group consisting of biofuel and biogas.

13. A method for determining greenhouse gas (GHG) emissions in the production of raw material for obtaining bioproducts, the production of raw material comprising: processes for extraction of raw material, processes for cultivation of raw material; processes for collection of raw material; processes for treatment of raw material waste and leakages; and processes for production of chemicals or products used in extraction and cultivation of raw material, characterized in that the method comprises the steps of:
a) retrieving from a database, by means of a GHG emissions modeling module using instructions received from a processing unit, the relevant parameters related to processes for extraction and cultivation of raw material;
b) retrieving from the database by means of the GHG emissions modeling module, using instructions received from the processing unit, relevant parameters related to processes for collection of raw material;
c) retrieving from the database by means of the GHG emissions modeling module, using instructions received from the processing unit, the relevant parameters related to processes for treatment of raw material waste and leakages;
d) retrieving from the database by means of the GHG emissions modeling module, using instructions received from the processing unit, the relevant parameters related to processes for production of chemicals or products used in extraction and cultivation of raw material;
e) providing the processing unit, through the data transmission means, with said relevant parameters, said processing unit having instructions for calculating the GHG emissions by means of the GHG emissions modeling module to which is connected;
f) processing in the processing unit the relevant parameters related to each process involved in the raw material production for calculating a partial GHG emissions value related to each process, and
g) adding up said partial values for calculating an overall GHG emissions level.

14. The method of claim 13, wherein the processing step f) comprises multiplying an activity data by an emission factor, according to the next equation:
PartialGHGEmissionValue=ActivityData·EmissionsFactor
being the activity data a characteristic parameter of the activity or of the means used to perform each process, which allows determining the emissions for a given period through calculation, and being the emission factor a parameter that indicates the quantity of a particular GHG emitted from a particular process by unit of activity data.

15. The method of claim 14, wherein the activity data for a process is composed by a combination of several parameters and constant factors.

16. The method of claim 13, wherein the raw material extraction and cultivation processes comprise at least one process selected from: soil tillage;
seed fabrication; sowing; irrigation; fertilizer application; pesticides application; N2O direct and indirect emissions from soil and organic amendment application.

17. The method of claim 16, wherein the recovering step a) comprises at least one action selected from:
retrieving, from the database by means of the GHG emissions modeling module, using instructions received from the processing unit, relevant parameters for the energy consumption of a tillage machinery;
retrieving, from the database by means of the GHG emissions modeling module, using instructions received from the processing unit, relevant parameters related to the quantity of seed fabrication;
retrieving, from the database by means of the GHG emissions modeling module, using instructions received from the processing unit, relevant parameters for the energy consumption of a sowing machinery;
retrieving, from the database by means of the GHG emissions modeling module, using instructions received from the processing unit, relevant parameters for the energy consumed in pumping irrigation water;
retrieving, from the database by means of the GHG emissions modeling module, using instructions received from the processing unit, relevant parameters for the energy consumption in the fertilizer application;
retrieving, from the database by means of the GHG emissions modeling module, using instructions received from the processing unit, relevant parameters for the energy consumption for applying pesticides;
retrieving, from the database by means of the GHG emissions modeling module, using instructions received from the processing unit, parameters relevant for the N₂O direct and indirect emissions, said emissions being associated to nitrous oxide emissions from soil due to direct nitrogen emissions, as well as leaching and volatilization of nitrogen, and
retrieving, from the database by means of the GHG emissions modeling module, using instructions received from the processing unit, relevant parameters for the emissions related to organic amendments application, said emissions being associated to substitution of nitrogen-based inorganic fertilizer.

18. The method of claim 13, wherein the processes for collection of raw material comprise at least one process associated to the production of raw material selected from: harvest; transport inside the parcel; transport to the raw material storing site; storage; and drying.

19. The method of claim 18, wherein the recovering step b) comprises at least one action selected from:
retrieving, from the database by means of the GHG emissions modeling module, using instructions received from the processing unit, relevant parameters for the energy consumption of a harvesting machinery;
retrieving, from the database by means of the GHG emissions modeling module, using instructions received from the processing unit, relevant parameters for the energy consumption of a transport means for transporting the harvested raw material inside the parcel;
retrieving, from the database by means of the GHG emissions modeling module, using instructions received from the processing unit, relevant parameters for the energy consumption of a transport means for transporting the harvested raw material from the parcel to the harvested raw material storage site;
retrieving, from the database by means of the GHG emissions modeling module, using instructions received from the processing unit, relevant parameters for the energy consumption related to the load and unload of the harvested raw material inside de storage site and the maintenance of controlled conditions in said storage site;
retrieving, from the database by means of the GHG emissions modeling module, using instructions received from the processing unit, relevant parameters for the energy and/or fuel consumption in harvested raw material drying operations.

20. The method of claim 13, wherein the processes for treatment of raw material waste and leakages comprise at least one process selected from: raking; baling, bale collecting and bale transporting.

21. The method of claim 20, wherein the recovering step c) comprises at least one action selected from:
retrieving, from the database by means of the GHG emissions modeling module, using instructions received from the processing unit, relevant parameters for the energy consumption of a raking machine;
retrieving, from the database by means of the GHG emissions modeling module, using instructions received from the processing unit, relevant parameters for the energy consumption of a baling machine;
retrieving, from the database by means of the GHG emissions modeling module, using instructions received from the processing unit, relevant parameters for the energy consumption of a machine for collecting bales; and
retrieving, from the database by means of the GHG emissions modeling module, using instructions received from the processing unit, relevant parameters for the energy consumption of a machine for transporting said bales to a bale storage site.

22. The method of claim 13, wherein the processes for production of chemicals or products used in extraction and cultivation of raw material comprise at least one process selected from: fabrication of fertilizers and fabrication of pesticides.

23. The method of claim 13, wherein the recovering step d) comprises at least one action selected from:
retrieving, from the database, by means of the GHG emissions modeling module, using instructions received from the processing unit, relevant parameters related to the composition and quantity of fertilizer used; and
retrieving, from the database, by means of the GHG emissions modeling module, using instructions received from the processing unit, relevant parameters related to the composition and quantity of pesticide used.

24. The method of claim 23, wherein the quantity of fertilizer used is estimated following the steps of:
retrieving from the database, by means of the GHG emissions modeling module, using instructions received from the processing unit, a parameter related to the overall production of raw material;
retrieving from the database, by means of the GHG emissions modeling module, using instructions received from the processing unit, a parameter related to the overall consumption of fertilizer;
retrieving from the database, by means of the GHG emissions modeling module, using instructions received from the processing unit, a parameter related to the theoretical fertilization ratio indicating the quantity of raw material produced per area unit;
retrieving from the database, by means of the GHG emissions modeling module, using instructions received from the processing unit, a parameter related to the overall surface involved in the production of raw material,
transmitting, using the data transmission means, the parameters calculated in the previous steps to the processing unit, and
calculating, using the GHG emissions modeling module, the quantity of fertilizer used, by adjusting the real fertilizer consumption with the theoretical fertilization ratio.

25. The method of claim 24, wherein the emission factor related to the fertilizer fabrication is calculated as a weighted average of the emission factor of each type of fertilizer according to the quantity used in each geographical area.

26. The method of claim 13, wherein the relevant parameters comprise parameters related to the type of the raw material and the location of the production of the raw material.

27. The method of claim 13, wherein the raw material is selected from at least one from the group consisting of: cereals, sugar cane, straw, forestry residues, forestry materials, energy crops, organic waste, wine alcohol, aquaculture and fishery residues, and oleaginous crops.

28. The method of claim 13, wherein the bioproduct comprises a bioplastic.

29. The method according to claim 13, wherein the bioproduct comprises a form of bioenergy.

30. The method according to claim 29, wherein the form of bioenergy is selected from a list consisting of biofuel and biogas.
